(19) United States
(12) Patent Application Publication
(10) Pub. No.: US 2018/0184393 A1
(43) Pub. Date: Jun. 28, 2018

(54) POWER MONITORING AND LOCATING SYSTEM FOR MOBILE CARRIERS

(71) Applicant: Linctronix Ltd., New Taipei City (TW)

(72) Inventor: Yu-Shun Lin, New Taipei City (TW)

(21) Appl. No.: 15/852,933

(22) Filed: Dec. 22, 2017

(30) Foreign Application Priority Data
Dec. 28, 2016 (TW) 105143516

(51) Int. Cl. H04W 64/00

(52) U.S. Cl. CPC H04W 64/00

(57) ABSTRACT

A power monitoring and locating system for mobile carriers includes a plurality of wireless positioning devices, a carrier power sensor, a carrier wireless positioning device and a server. The wireless positioning devices send a plurality of wireless signals and the carrier wireless positioning device receives the wireless signals to obtain RSSI (Received Signal Strength Indication) corresponding to the wireless signals. The carrier wireless positioning device sends carrier wireless signals including the wireless signals, the corresponding RSSIs, and the power information. The server which including a database storing the locations of the wireless positioning devices receives the carrier wireless signals. The server positions the carrier wireless positioning device according to the database and the carrier wireless signals and obtains the power information.

### CROSS-REFERENCE TO RELATED APPLICATIONS

This application claims the priority benefit of Taiwan Application Serial No. 105143516 filed Dec. 28, 2016 the disclosure of which is incorporated herein by reference.

### BACKGROUND OF THE INVENTION

### Field of the invention

The present invention relates to a mobile carrier power monitoring and locating system, more particularly, relates to a locating system for locating a mobile carrier using a wireless signal.

### Background

The Global Positioning System (GPS), developed by the US Department of Defense, uses a global satellite navigation system consisting of 24 satellites in which include three ready-to-use satellites. The use of civil open C/A code standard measurement method can get tens of meters of precision, which is a radio positioning method. GPS was originated from NAVSTAR satellite for military use; however, due to the time evolution and the changes in the international political situations, GPS can not only be used in the military but also be used in the situation with other economic value or for more important purposes, such as checking drivers' locations while driving.

Although GPS is widely used in human life, there are still many restrictions. For example, GPS can only be used in a good signal location; namely, if the area is the basement, the GPS cannot be used due to the problems of building shielding. Moreover, although the accuracy of GPS can reach tens of meters, it is still not accurate if used in a more intensive positioning area. Finally, since the use of GPS positioning is often accompanied by a lot of power consumption, the long-term use of the GPS is easy to lead to the power shortage of the devices.

### SUMMARY OF THE INVENTION

In view of the above, the present invention provides a power monitoring and locating system for mobile carriers. In an embodiment, the power monitoring and locating system for mobile carriers of present invention comprises a plurality of wireless positioning devices, a carrier power sensor, a carrier wireless positioning device, and a location server. The plurality of wireless positioning, configured in a predetermined area and in the mobile range of the mobile carrier respectively, is used to send a wireless positioning broadcast signal periodically. The carrier wireless positioning device, fixed on the mobile carrier, is used to receive more than one wireless positioning broadcast signal, and sends more than one carrier wireless signal to the location server. The carrier wireless positioning device connects a carrier power sensor by the USB, RS-232, Ethernet, I2C, SPI, SMBUS or LPC to read the battery information of a carrier battery detected by the carrier power sensor. Each carrier wireless signal comprises a carrier identity, a wireless positioning broadcast signal in whole or in part, according to the wireless positioning broadcast signal calculation of a RSSI (Received Signal Strength Indicator) and the battery information of a carrier battery. The location server comprises a database, and the database stores a coordinate position of the wireless positioning devices. The location server obtains the positioning coordinates of the mobile carrier through the positioning algorithm based on the plurality of RSSI and the information stored in the database, and judges the battery information of the carrier wireless positioning device. If the battery information is lower than a set value, the location server sends a low battery warning.

In this embodiment, each wireless positioning device respectively comprises a position wireless module, a position power sensor, and a position battery. The wireless positioning devices send the wireless positioning broadcast signal via the position wireless module, wherein, the wireless positioning broadcast signal comprises a wireless positioning device identifier, a battery information, and a location identifier. The carrier wireless positioning device also comprises a carrier wireless module for receiving the wireless positioning broadcast signal and sending the carrier wireless signal. In this embodiment, the position wireless module and the carrier wireless module can be a Bluetooth module. In the other embodiment, the carrier wireless positioning device comprises a wireless transmission module for sending the carrier wireless signal. Each carrier wireless signal can be a Bluetooth signal or a wireless area network signal.

In the other embodiment, the location server can store an area message corresponding to an area of the predetermined area. When the carrier wireless positioning device enters the area, the location server sends an area information including the area message to the carrier wireless positioning device.

Compared with the prior art, the power monitoring and locating system for mobile carriers of the present invention uses the Bluetooth module to achieve low cost, low power consumption and high safety, and solves the problem of poor indoor signal by using the self-provided servers and transceivers. The present invention is superior to the GPS system in a small range of positioning capabilities. The present invention utilizes the carrier power sensor to control the instant power of each carrier wireless positioning device and to charge it in advance to ensure that there is no shortage of electricity during use. Compared with the GPS system, the present invention is more suitable for the use in the indoor environment of the positioning system.

The advantages and spirits of the invention can be understood by the following recitations together with the appended drawings.

### BRIEF DESCRIPTION OF THE APPENDED DRAWINGS

FIG. 1 shows a function block of an embodiment of the power monitoring and locating system for mobile carriers of the present invention.

FIG. 2 shows a schematic diagram of the power monitoring and locating system for mobile carriers of the present invention.

FIG. 3 shows a function block of other embodiment of the power monitoring and locating system for mobile carriers of the present invention.

FIG. 4 shows the first signal transmission mode of the power monitoring and locating system for mobile carriers of the present invention.

FIG. 5 shows the second signal transmission mode of the power monitoring and locating system for mobile carriers of the present invention.

FIG. 6 shows a function block of an embodiment of the carrier wireless positioning device of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

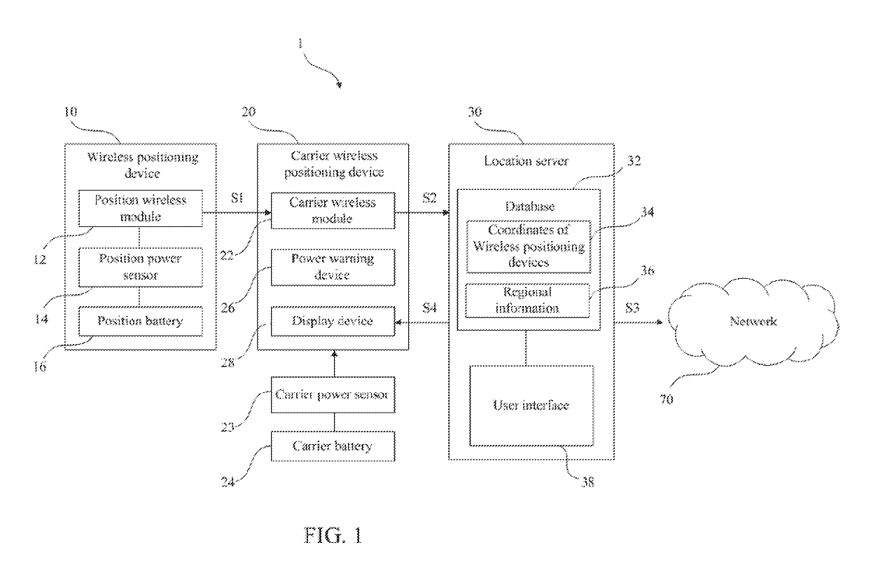

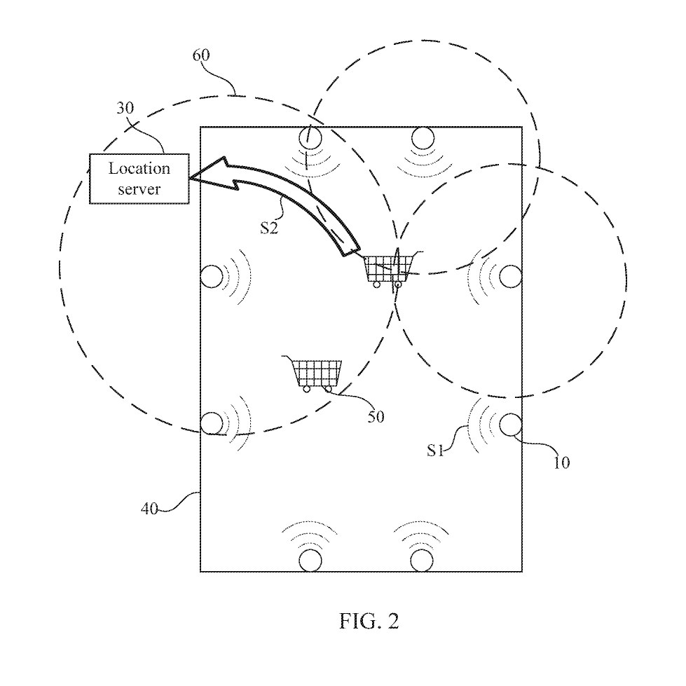

Please refer to FIG. 1 and FIG. 2; FIG. 1 shows a function block of an embodiment of the power monitoring and locating system 1 for mobile carriers of the present invention. FIG. 2 shows a schematic diagram of the power monitoring and locating system 1 for mobile carriers of the present invention.

As shown in FIG. 1 and FIG. 2, the power monitoring and locating system for mobile carriers comprises a plurality of wireless positing devices 10, one or more carrier wireless positioning device 20 and a location server 30, wherein the plurality of wireless positioning devices 10 are configured in the predetermined area 40, respectively. The carrier wireless positioning device 20 is fixed to the mobile carrier 50, and the location server 30 is configured in a cloud data center or a near-end server that is connectable through an Internet or an intranet, but is not limited thereto.

Please refer to the FIG. 1; the wireless positioning device 10 comprises a position wireless module 12, a position power sensor 14 and a position battery 16, wherein the latest battery information of the positioning battery 16 is periodically obtained by the position power sensor 14. The position wireless module 12 can be a Bluetooth module, a Wi-Fi module, an IEEE802.15.4, a Zigbee, or other wireless area network module, but not limited thereto. Each of the wireless positioning devices 10 periodically sends a wireless positioning broadcast signal Si through the position wireless module 12, and the wireless positioning broadcasting signal Si comprises a wireless positioning device identifier of the wireless positioning device 10, the latest battery information of the position battery 16, and the location identifier, wherein the location identifier is location-dependent coding within the system, and when the wireless positioning device 10 is deployed at a different location, the location identifier will also change.

In practical application, the position power sensor 14 can be integrated within the position wireless module 12 or integrated into the system signal chip (SoC) employed by the position wireless module 12 or as an independent power detection element.

The carrier wireless positioning device 20 comprises a carrier wireless module 22 and connects the carrier power sensor 23 and carrier battery 24, wherein the latest battery information of the carrier battery 24 is obtained by the carrier power sensor 23. The carrier wireless module 22 is the same wireless transmission protocol as the position wireless module 12 of the wireless pointing device 10. The carrier wireless positioning device 20 receives one or more wireless positioning broadcast signals S1 through the carrier wireless module 22, and calculates the corresponding RSSI (Received Signal Strength Indicator) based on each of the wireless positioning broadcast signals S1, and then generates one or more carrier wireless signals S2. Each carrier wireless signal S2 comprise a location identifier of one of a wireless positioning broadcast signal S1, a RSSI corresponding to the wireless positioning broadcast signal S1 and the latest power information of the carrier battery 24. Each carrier wireless signals S2 can further comprise the latest battery information of the position battery 16 and the wireless positioning device identifier of the wireless positioning broadcast signal S1. In this embodiment, the carrier battery 24 can provide additional electrical or electromechanical devices on the mobile carrier 50 in addition to the carrier wireless positioning device 20. In addition, in other embodiments, the carrier battery 24 can be a battery built-in the mobile carrier 50 and further provides the power to the carrier wireless positioning device 20, and the carrier power sensor 23 connects to the mobile carrier 50 to monitor the latest power information of the carrier battery 24.

In practical application, the carrier power sensor 23 can be integrated within the carrier wireless module 22 or integrated into the system signal chip (SoC) employed by the carrier wireless module 22 or as an independent power detection element.

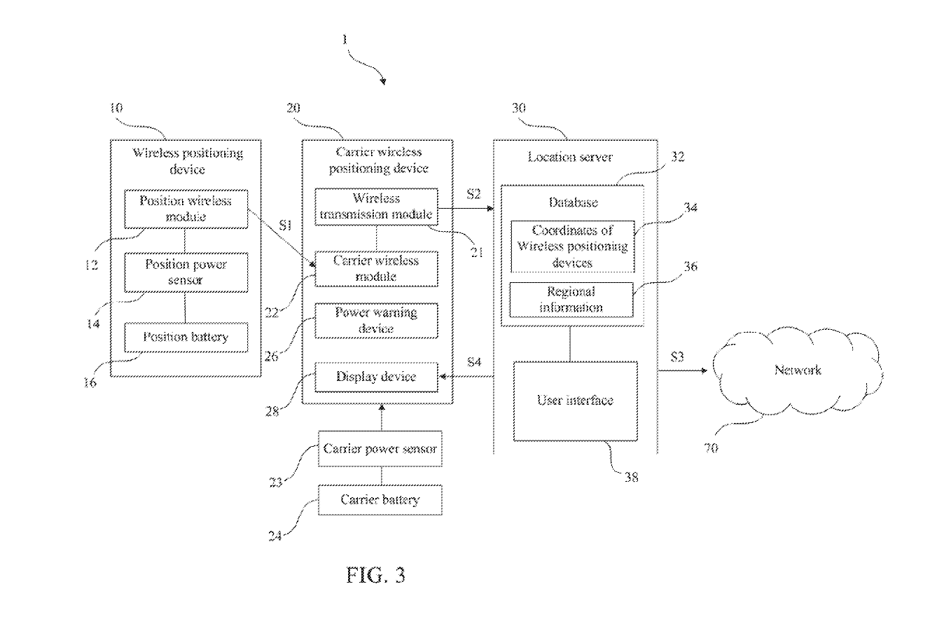

Please refer to FIG. 3; FIG. 3 shows a function block of other embodiment of the power monitoring and locating system 1 for mobile carriers of the present invention. As shown in FIG. 3, in other embodiment, the carrier wireless location device 20 can further comprise a wireless transmission module 21. The carrier wireless positioning device 20 receives more than one wireless positioning broadcast signal Si through the carrier wireless module 22 and generates one or more carrier wireless signals S2, and the carrier wireless signals S2 are sent to location server 30 through the wireless transmission module. Wherein, the position wireless module 12 of the wireless positioning device 10 and the wireless transmission module 21 can be a different wireless transmission protocol. For example, the wireless positioning device 10 sends the wireless positioning broadcast signal S1 via Bluetooth protocol to the carrier wireless positioning device 20, and the carrier wireless positioning device 20 sends the carrier wireless signal S2 to the location server 30 via the wireless transmission module 21 using the WiFi protocol.

The location server 30 can further comprises a database 32 and an area network. The database 32 is used to record all the coordinates 34 of wireless positioning devices, and the area network can be a wired area network or a wireless area network. The location server 30 receives the carrier wireless signal S2 via the area network and calculates an estimated distance 60 based on the RSSI within the carrier wireless signal S2 by the relationship between the radio wave signal strength and the distance. The estimated distance 60 is the relative distance between the mobile carrier 50 and the wireless positioning device 10 that sends the wireless positioning broadcast signal S1. The estimated distances 60 between the mobile carrier 50 and the plurality of wireless positioning devices 10 can be obtained by using the plurality of carrier wireless signals S2, and then a positioning coordinate of the carrier device 50 can be calculated by the positioning algorithm with the plurality of coordinates 34 of wireless positioning device stored in the database 32. The schematic diagram of positioning is shown in FIG. 2.

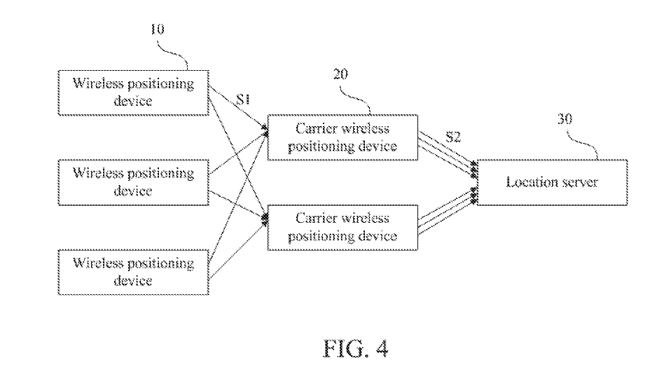

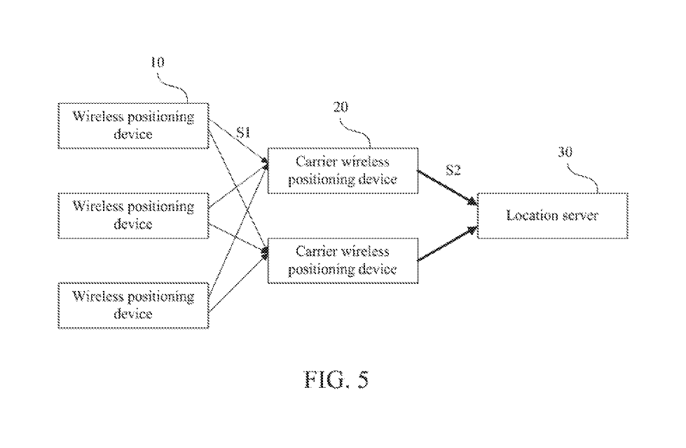

Please refer to the FIG. 4 and FIG. 5; the FIG. 4 shows the first signal transmission mode of the power monitoring and locating system 1 for mobile carriers of the present invention, and the FIG. 5 shows the second signal transmission mode of the power monitoring and locating system 1 for mobile carriers of the present invention. As shown in FIG. 4, in an embodiment, each of the wireless positioning broadcast signals Si is sent to the carrier wireless positioning device 20, and the carrier wireless positioning device 20 generates a carrier wireless signal S2 while receiving the wireless positioning broadcast signal S1. In FIG. 4, the two carrier wireless positioning devices 20 receive three wireless positioning broadcasting signals S1, and send three carrier wireless signals S2 to the location servers 30, respectively. Each of the carrier wireless signals S2 comprises a corresponding wireless positioning broadcast signal S1, respectively. Then, the location server 30 calculates the positioning coordinates of the mobile carriers 50 by comparing the coordinates 34 of wireless positioning devices stored in the database 32. As shown in FIG. 5, in another embodiment, the carrier wireless positioning devices 20 send a single carrier wireless signal S2 to the location server 30 respectively after receiving three wireless positioning broadcast signals Si. This carrier wireless signal S2 comprises the three wireless positioning broadcasting signals S1 above-described. The location server 30 compares the coordinates 34 stored in the database 32 with the three wireless positioning broadcasting signals S1 and the corresponding RSSI included in the carrier wireless signal S2 to calculate the positioning coordinates of the mobile carrier 50. In this embodiment, three wireless positioning devices 10 are taken as an example, but the number of wireless positioning devices 10 is not limited in practice. For example, within a limited time, no matter how many wireless positioning broadcasting signals S1 the carrier wireless positioning device 20 received, the carrier wireless positioning device 20 sends a single carrier wireless signal S2 that includes all of the wireless positioning broadcasting signals S1 the carrier wireless positioning device 20 received within the limited time to the location server 30.

In the practical application, a wireless network is deployed around the predetermined area 40 of the mobile carrier 50. The wireless network can be connected to an Internet or an intranet, and the location server 30 can receive one or more carrier wireless signals S2 sent from the carrier wireless positioning device 20 via the wireless network. In a particular embodiment, the wireless network can be a wireless area network. A wireless area network Access Point (AP) receives the carrier wireless signals S2, and then the wireless area network AP sends the carrier wireless signals S2 to the location server 30 via the Internet or the intranet. In another embodiment, the wireless network can be a Bluetooth network. A Bluetooth AP receives the carrier wireless signals S2, and then the Bluetooth AP sends the carrier wireless signals S2 to the location server 30 via the Internet or the intranet by a network transfer mechanism. The above-described network transfer mechanism can be a Bluetooth transfer to a wireless area network or a wired area network, and the wireless area network or the wired area network can be connected to an Internet or an intranet. The network transfer mechanism can transfer the Bluetooth through the WiFi transfer or the wired area network transfer.

Please refer to the FIG. 1 and FIG. 2 again; in this embodiment, the active map of the predetermined area 40 can be stored in the location server 30; for example, in the database 32. The location server 30 can further comprises a user interface 38 for displaying the active map, the coordinates 34 of the wireless positioning device 10, and the location of the mobile carrier 50. The positioning server 30 records the battery information of the carrier battery 24 and the position battery 16 after receiving the carrier wireless signals S2. When the carrier battery 24 or the position battery 16 is below a set value, the low-power carrier battery 24 or the low-power positioning battery 16 is displayed on the active map in a specific display mode. The specific display mode can be a signal point flashing or the signal point changes color, but not limited thereto. In addition, if the battery is below the set value, the location server 30 sends a low battery warning S3. The location server 30 can send the low battery warning S3 to the external device via the network 70; for example, sending the SMS or the MMS to the preset mobile device gate number via the of the mobile communication network, or sending an email via SMTP, POP3 or other email protocol to the default email address, or sending a message via the communication software such as Line, WhatsAPP, and Skype, to the default communication account, or sending the low battery warning S3 to the web page through the HTTP server of the location server.

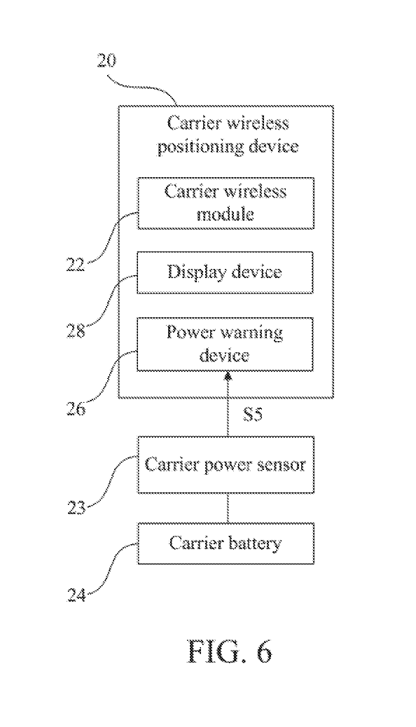

Please refer to the FIG. 6; in another embodiment, the carrier wireless positioning device 20 can comprise a power warning device 26. The power warning device 26 is connected to the carrier power sensor 23. When the carrier battery sensor 23 detects the power of the carrier battery 24 is below a set value, the carrier battery sensor 23 sends a second low battery warning S5 to the power warning device 26. The power warning device 26 can broadcast the sound of the low battery warning or display the low battery warning on the screen, but not limited thereto.

In the practical application, a coordinate area can be set as a mobile carrier homing area in the active map. When the mobile carrier 50 leaves the mobile carrier homing area, the location server 30 checks the received latest battery information. If the latest battery information is lower than the set value, the location server 30 sends the low battery warning S3 via the wireless network.

In the particular embodiment of FIG. 1, the location server 30 comprises regional information 36, which can be stored in the database 32 and can also be stored in another storage device. The regional information 36 corresponds to an area in the active map, and when the carrier wireless positioning devices 20 enters the area, the location server 30 sends area information S4 that comprises the regional information 36 to the carrier wireless positioning device 20. The carrier wireless positioning device 20 can further comprises a display device 28 for displaying or broadcasting the area information S4 and the regional information 36. Where the area information S4 can be a warning message for warning the mobile carrier 50 enter a warning area; the area information S4 can also be a dangerous message for warning that the mobile carrier 50 enters a dangerous area; the area information S4 can be a navigation message for guiding the mobile carrier 50; and the area information S4 can also be an advertisement message for displaying or broadcasting the advertisements associated with this area. In addition, in this embodiment, the power warning device 26 and the display device 28 are individually used to play or display the second low battery warning S5 or the area information S4, but in practice, the power warning device 26 and the display device 28 can be combined into a device to simultaneously play or display a second low battery warning S5 and to receive the area information S4.

In a particular embodiment, the mobile carrier 50 can be a care medical cart, and the carrier battery 24 is a medical battery for a care medical cart. In the practical application, the carrier wireless positioning device 20 can comprises a battery communication interface, wherein the battery communication interface can be USB, RS-232, RS-485, UART, Ethernet, I2C, SPI, SMBUS or LPC. The carrier power sensor 23 is connected to the medical battery, and the carrier wireless positioning device 20 obtains the battery information via the battery communication interface and the carrier power sensor 23 by a transmission agreement.

In another embodiment, the carrier wireless positioning device 20 can be a personal computer. The personal computer has a carrier wireless module 22, a battery communication interface, and a transmission application. Wherein the transmission application can send one or more carrier wireless signals S2 via the carrier wireless module 22.

In another embodiment, the mobile carrier 50 can be a shopping cart, and the carrier wireless positioning device 20 is mobile device configured on the shopping cart. The mobile device has a carrier wireless module 22, a carrier battery 24 and a transmission application executed on the mobile device. The transmission application can send one or more carrier wireless signals S2 via the carrier wireless module 22.

In another embodiment, the mobile carrier 50 can be an unmanned carrier, and the carrier wireless positioning device 20 can be a control computer of the unmanned carrier. The control computer has a carrier wireless module 22, a carrier battery 24, and a transmission application. The transmission application sends one or more carrier wireless signals S2 via the carrier wireless module 22. In addition, the location server 30 can send a move command to an unmanned carrier that includes a moving distance to control the unmanned carrier, and can control the unmanned carrier moving along a moving route by sending a plurality of movement commands.

In the practical application, a charging area of the unmanned carrier can be set as the above-mentioned mobile carrier homing area, and the control computer of the unmanned carrier can comprise the weight sensor to measure the load information of the unmanned carrier. The carrier wireless signals S2 can comprise the load information. The location server 30 can store the load, distance and power consumption formula of the unmanned carrier and calculate the power required for homing based on the load information of the unmanned carrier and the distance between the unmanned carrier and the mobile carrier homing area. If the carrier power information of the unmanned carrier minus power required for homing is less than a power safe value, the location server 30 can issue a low battery warning S3 in the user interface 38, wherein the power safe value can be set in the user interface 38.

The carrier power sensor 23 and the positioning power sensor 14 of the above-described embodiments are electronic element or electronic circuits that can provide an electric power detection algorithm. Wherein, the power detection algorithm can be open circuit voltage method that obtains the electric power by the open circuit voltage corresponding to the state of charge checklist. The power detection algorithm can also be Coulomb method. The Coulomb method is the principle of operation in the battery charge/discharge path to connect a detection resistor, and uses the ADC to measure the voltage across the detection resistor. The voltage can be converted to the current value that the battery is charging or discharging. The Real-Time Counter (RTC) integrates the current value over time to obtain the flowing Coulomb. The power detection algorithm can also be a dynamic voltage algorithm. The dynamic voltage algorithm can calculate the battery charge state based on the battery voltage. This method is based on the difference between the battery voltage and the open circuit voltage of the battery to estimate the incremental or decrement of the state of charge.

The positioning algorithm of the embodiments described above can use a single point and a distance to designate a circle as the positioning area; or two circles are designated by two points and respective distances and the shuttle type of the intersection as the positioning area. Alternatively, three points and the distance for the triangular or trilateral positioning use the three points and the distance to designate three circles of the intersection as the positioning area. Moreover, multipoint using the cellular algorithm, multiple triangles takes its most overlapping intersection of the region to calculate the positioning area. After the above process, it is added to the stochastic process of the random process to obtain the positioning area through several convergences, wherein the single point, the two points, and the three points are all the points where the wireless positioning device 10 is located.

The unique device identifier of the wireless positioning device 10 and the carrier wireless positioning device 20 in the above-embodiment can be a Bluetooth MAC, a wireless network MAC, a mobile device code, a mobile device SIM card encode, a sequence number, or a unique identifier that is recorded within the analysis server for each device identification.

In the above-mentioned embodiments, the Bluetooth module can be any Bluetooth protocol defined by the Bluetooth Association, such as a variety of Bluetooth devices like Bluetooth 2.0 protocol, Bluetooth 3.0 protocol, or Bluetooth 4.0 protocol.

In the above-mentioned embodiments, the wireless area network is an 802.11 communication protocol specification of any version defined by WiFi or IEEE, for example, 802.11, IEEE 802.11a, 802.11b, 802.11g, 802.11h, 802.11n, 802.11p, 802.11ac, 802.11ah, 802.11aq, 802.11ax and so on.

In the above-mentioned embodiments, the wired area network can be a wired network such as an Ethernet network, a fiber network (FTTx), a power line communication, or other wired network that can deliver network packets.

The wireless mobile communication protocol in the above embodiment is Release 4, Release 5, Release 6, Release 7, Release 8, Release 9, Release 10, Release 11, Release 12, Release 13, Release 14 of 3GPP Association, or other mobile telecommunications agreements approved by the ITU International Telecommunication Union.

Compared with the prior art, the power monitoring and locating system for mobile carriers of the present invention uses the Bluetooth module to achieve low cost, low power consumption and high safety, and solves the problem of poor indoor signal by using the self-provided servers and transceivers. The present invention is superior to the GPS system in a small range of positioning capabilities. The present invention utilizes the carrier power sensor to control the instant power of each carrier wireless positioning device and to charge it in advance to ensure that there is no shortage of electricity during use. Compared with the GPS system, the present invention is more suitable for the use in the indoor environment of the positioning system. Compared to the iBeacon technology, there will be no problem that the user's hand-held device has no receiver, the user's hand-held device is consuming too much power or the system is incompatible since the wireless positioning device (transmitter) and the carrier wireless positioning device (receiver) of the power monitoring and locating system for mobile carriers of the present invention are provided by the industry,. In addition, the present invention mounts the carrier wireless positioning device (receiver) on the mobile carrier provided by the industry, not only providing the advertisement information, the warning information, the preferential information, the map information, and the battery information, but also reducing the inconvenience of using, which improves the user's willingness to use.

With the examples and explanations mentioned above, the features and spirits of the invention are hopefully well described. More importantly, the present invention is not limited to the embodiment described herein. Those skilled in the art will readily observe that numerous modifications and alterations of the device can be made while retaining the teachings of the invention. Accordingly, the above disclosure should be construed as limited only by the metes and bounds of the appended claims.

What is claimed is:

1. A power monitoring and locating system for mobile carriers comprising:
a plurality of wireless positioning devices, configured in a predetermined area respectively, for sending a wireless positioning broadcast signal periodically;
a carrier power sensor, connected to a carrier battery of a mobile carrier, for measuring a battery information of the carrier battery;
a carrier wireless positioning device, fixed on the mobile carrier and connected to the carrier power sensor, for receiving the wireless positioning broadcast signals, and generating a plurality of received signal strength indicators corresponding to the wireless positioning broadcast signals; wherein, the carrier wireless positioning device generates at least one carrier wireless signal, and the carrier wireless signal comprises at least one wireless positioning broadcast signal, the received signal strength indicator corresponding to the wireless positioning broadcast signal, and the battery information; and
a location server, for receiving the carrier wireless signal, comprising a database, wherein the database stores coordinate position of the wireless positioning devices, and the location server obtains a positioning coordinate of the mobile carrier according to at least one carrier wireless signal and the database.

2. The power monitoring and locating system for mobile carriers of claim 1, wherein the wireless positioning devices comprise a position battery and a position power sensor.

3. The power monitoring and locating system for mobile carriers of claim 1, wherein the wireless positioning devices respectively comprise a position wireless module, and the wireless positioning devices send the wireless positioning broadcast signal periodically via the position wireless module; wherein, the wireless positioning broadcast signal comprises a wireless positioning device identifier, a battery information, and a location identifier.

4. The power monitoring and locating system for mobile carriers of claim 1, wherein the carrier wireless positioning device comprises a carrier wireless module, and the carrier wireless positioning device receives the wireless positioning broadcast signal via the carrier wireless module.

5. The power monitoring and locating system for mobile carriers of claim 4, wherein the carrier wireless module sends at least one carrier wireless signal periodically.

6. The power monitoring and locating system for mobile carriers of claim 4, wherein the carrier wireless positioning device further comprises a wireless transmission module connected to the carrier wireless module, and the wireless transmission module sends at least one carrier wireless signal periodically.

7. The power monitoring and locating system for mobile carriers of claim 1, wherein the location server comprises a user interface for displaying a map of the predetermined area and displaying the location of the carrier wireless positioning device on the map of the predetermined area; wherein, the user interface displays the battery information of the carrier wireless positioning device and sends a low battery warning when the battery information is lower than a set value.

8. The power monitoring and locating system for mobile carriers of claim 7, wherein the location server sends the low battery warning to at least one of a mobile phone, an e-mail, a web page, and a communication software via a network.

9. The power monitoring and locating system for mobile carriers of claim 1, wherein the location server comprises an area message corresponding to an area of the predetermined area; when the carrier wireless positioning device enters the area, the location server sends an area information including the area message to the carrier wireless positioning device.

10. The power monitoring and locating system for mobile carriers of claim 1, wherein the carrier power sensor uses one of open circuit voltage method, Coulomb method and dynamic voltage algorithm to calculate the battery information.
